(19) United States
(12) Patent Application Publication
(10) Pub. No.: US 2008/0181835 A1
(43) Pub. Date: Jul. 31, 2008

(54) STEAM REFORMING PROCESS SYSTEM FOR GRAPHITE DESTRUCTION AND CAPTURE OF RADIONUCLIDES

(76) Inventor: J. Bradley Mason, Pasco, WA (US)

Correspondence Address: NEXSEN PRUET, LLC, P.O. BOX 10648, GREENVILLE, SC, 29603, US

(21) Appl. No.: 11/937,650

(22) Filed: Nov. 9, 2007

Related U.S. Application Data
(60) Provisional application No. 60/872,164, filed on Dec. 1, 2006.

(51) Int. Cl. C01G 1/02

(52) U.S. Cl. 423/249

(57) ABSTRACT

A system for the treatment and recycling of graphite containing radionuclides including a two stage method that employes a thermal roaster that is operatively connected to a steam reformer. In the first stage, radioactive graphite is roasted or heated to volatize a first amount of radionuclides contained in the graphite. In the second stage, the roasted graphite is reacted with steam or gases containing water vapor so that a second amount of radionuclides is removed. Optionally, the present system also processes the radionuclides to enable their disposal.

### CROSS REFERENCE TO RELATED APPLICATIONS

The present application claims the benefit of priority of U.S. Provisional No. 60/872,164, filed Dec. 1, 2006.

### STATEMENT REGARDING FEDERALLY SPONSORED RESEARCH OR DEVELOPMENT:

Not applicable.

### REFERENCE TO A SEQUENCE LISTING, A TABLE, OR A COMPUTER PROGRAM LISTING COMPACT DISC APPENDIX

Not Applicable.

### BACKGROUND OF THE INVENTION

Graphite, which consists predominantly of the element carbon, is used as a moderator in a number of nuclear reactor designs, such as the MAGNOX and AGR gas cooled reactors in the United Kingdom, and the RBMK design in Russia. During construction, the moderator of the reactor is usually installed as an interlocking structure of graphite bricks. At the end of reactor life, the graphite moderator, typically weighing about 2,000 tons, is a form of radioactive waste which requires safe disposal.

Graphite is a relatively stable chemical form of carbon, which is in many ways suitable for direct disposal without processing. However, after neutron irradiation, the graphite will contain stored Wigner energy. The potential for release of this energy needs to be accommodated in any strategy which relies on disposing of the graphite in unprocessed form. Alternatively, processing the graphite before disposal can allow the safe release of any stored Wigner energy.

The graphite also contains significant quantities of radionuclides from neutron induced reactions, both in the graphite itself and in the minor impurities which it contains. Because of the structure of graphite, which includes loosely packed foliates or layers, the radioisotopes can become trapped within the spaces or pores of the graphite. The radioisotope content can conveniently be divided into two categories—short-lived isotopes and long-lived isotopes. Short-lived isotopes (such as cobalt-60) make the graphite difficult to handle immediately after reactor shutdown, but they decay after a few tens of years. Long-lived isotopes (principally carbon-14) are of concern through the possibility of their discharge to the biosphere. Processing the graphite offers the opportunity to separate the majority of the graphite mass (carbon) from the short-lived radioisotopes. This in turn facilitates disposal of the graphite waste shortly after the end of the reactor life, and may permit recycling.

Because of the characteristics of graphite and its mass, the most common procedure to date for decommissioning of graphite moderated reactors is to store the reactor core in-situ for a period of tens of years following reactor shut-down. During this period, short-lived radioisotopes decay sufficiently to allow eventual manual dismantling of the graphite moderator. Most plans then assume that the graphite will be disposed of in its existing chemical form, with appropriate additional packaging to prevent degradation or release over the long period of carbon-14 decay.

Storage has certain negative consequences, such as the following: 1) an implication of long-term financial liability, 2) a visually intrusive storage structure that has no productive purpose, and 3) a requirement imposed on a future generation (which gained no benefit from the original asset) to complete eventual clearance. If the storage alternative is to be replaced by shorter term management, it is essential for the graphite to be processed in a safe and radiologically acceptable manner.

Thus, there remains a need for a better way to handle radioactively contaminated graphite than simply storing it.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The present invention includes a system for the treatment and recycling of graphite containing radionuclides. Generally, the system of the present invention includes a two stage method that employs a thermal roaster that is operatively connected to a steam reformer. In the first stage, radioactive graphite is roasted or heated to volatize a first amount of radionuclides contained in the graphite. In the second stage, the roasted graphite is reacted with steam or gases containing water vapor so that a second amount of radionuclides is removed. Optionally, the present system also processes the radionuclides to enable their disposal.

A feature of the present invention includes the use of a thermal roaster for heating the radioactive graphite prior to reacting the radioactive graphite in the steam reformer. This method provides for a better concentration of the radionuclides so that processing steps are made safer and more efficient and the final volume of radioactive waste that requires ultimate solid disposal is reduced. Furthermore, by removing a first portion of radionuclides, the steam reforming process of the invention also becomes more manageable as less radioactive materials will potentially be discharged as gases to the environment.

### BRIEF DESCRIPTION OF THE DRAWINGS

In the drawings,

FIG. 1 is schematic illustration of a system for treating radioactive graphite according to a preferred embodiment of the present invention;

FIG. 2 is a front view of a thermal moving bed roaster used in treating radioactive graphite according to a preferred embodiment of the present invention;

FIG. 3 is a front view of a steam reformer used in treating radioactive graphite according to a preferred embodiment of the present invention;

FIG. 4A is a front view of a steam reformer used in treating radioactive graphite according to a first alternative embodiment of the present invention; and

FIG. 4B is a front view of a steam reformer used in treating radioactive graphite according to a second alternative embodiment of the present invention;

FIG. 4C is a front view of a steam reformer used in treating radioactive graphite according to a third alternative embodiment of the present invention;

FIG. 4D is a front view of a steam reformer used in treating radioactive graphite according to a fourth alternative embodiment of the present invention;

FIG. 4E is a front view of a steam reformer used in treating radioactive graphite according to a fifth alternative embodiment of the present invention.

### DETAILED DESCRIPTION OF THE PREFERRED EMBODIMENTS

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The present invention is a process applied to graphite materials previously used as the moderator in the core of a thermal nuclear reactor and which are no longer required for this purpose. It also applies to any other graphite materials (fuel element sleeves, braces etc.) irradiated in the neutron flux of a nuclear reactor core.

In a preferred embodiment, the present invention provides a process including the following steps: (i) heating the radioactive graphite in a thermal roaster; (ii) removing a first amount of radionuclides; (iii) reacting the radioactive graphite with a reforming agent, such as superheated steam or gases containing water vapor, to form hydrogen, carbon monoxide and carbon dioxide; (iv) reacting the hydrogen and carbon monoxide from step (iii) with an oxidizing agent to form water and carbon dioxide; (v) removing a second amount of radionuclides; and (vi) processing of radioactive contaminants. Step (iii) is a type of process that is generally referred to in the art as “steam reforming”. The reaction in step (iii) may be carried out with the addition of oxygen to the steam or gases containing water vapor to provide exothermic reaction energy for the process. The addition of oxygen also enables the temperature of the steam reforming reaction to be controlled. As used herein, the term “agent” refers to a substance that can bring about a chemical reaction. Among other radionuclides commonly present in this type of graphite, the process of the present invention can effectively remove and treat any H-3, Cl-36, C-14, Fe-55, and Co-60 present in the graphite, as well as other radionuclides.

The advantage of the process of the present invention that utilizes steam and oxygen for gasification of the graphite, as compared to the use of air or oxygen enriched air combustion of radioactive graphite, is that it can be carried out under appropriately controlled containment conditions. For example, the steam reformer process can use cylindrical pressure vessels that provide a higher level of confinement than typical box type combustion-fired incinerators. Even more important is that air-fired combustion of graphite releases a large amount of heat that requires the addition of significant inert cooling gases to the incinerator to achieve reasonable graphite throughputs, however, this is not practical as the introduction of more inert gases substantially increases the offgas flow such that collection and separation of the volatile H-3, C-14, and Cl-36 from such a proportionately large off-gas volume requires a much higher collection efficiency as the radioactive gases will be diluted by the inert cooling gas and the nitrogen in the air combustor and the off-gas treatment systems must be typically 10 to 20 times larger than is needed for an equivalent steam reformer unit where the off-gas flow is mainly steam that can be readily condensed and recycled back to the process as steam. The steam reformer also has the very significant advantage that very high levels of energy provided by oxygen oxidation of the graphite will be adsorbed by the corresponding adsorption of energy by the endothermic steam reforming reactions of steam with graphite. Additionally, the use of a deep bed in the reformer allows introduction of water to directly cool and adsorb the net positive heat from the combined steam reforming and oxygen oxidation of the graphite in the bed. This results in a very high graphite gasification rate for a relatively compact and more easily shielded reformer. In summary, the loss of hazardous or radioactive materials in the off-gas is therefore reduced or even eliminated and the low volume of off-gas simplifies handling including the possibility of achieving substantially zero gaseous emissions. The treatment throughput rate is higher for a given size hardware and capital investment. Further, the process enables the Wigner energy stored in the radioactive graphite to be released in a controlled manner.

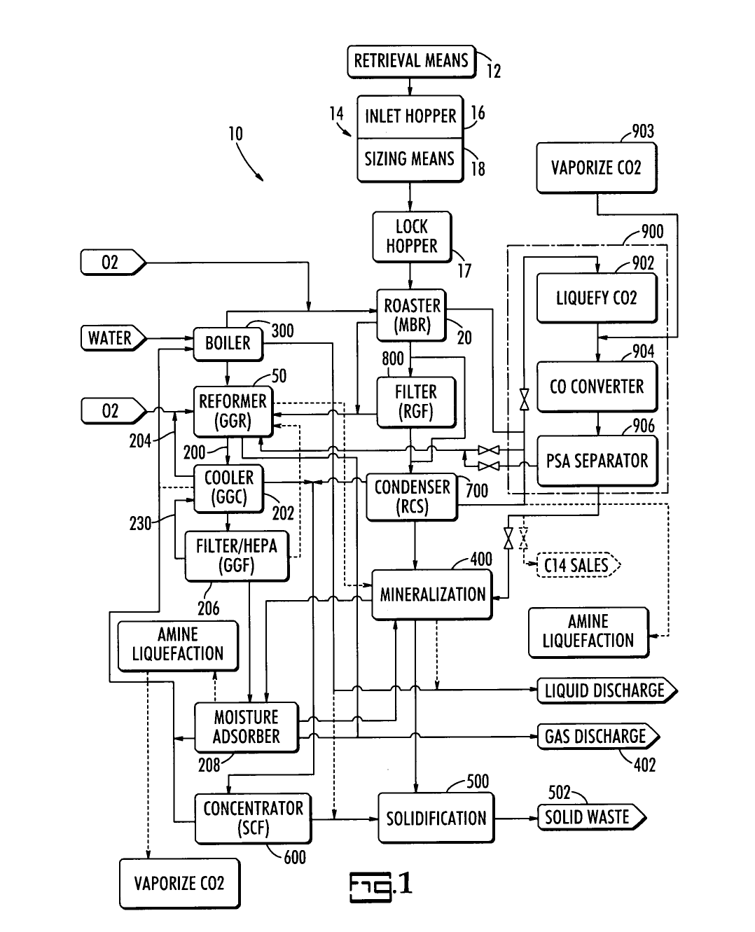

The present invention will be further described with reference to FIG. 1 of the accompanying drawings which is an overview flow diagram of one means 10 of carrying out the process of the present invention. Referring to the drawing, the radioactive graphite is prepared for introduction to the first stage of the system. First, bulk radioactive graphite is removed and retrieved from a nuclear reactor core by means for retrieval 12. Retrieval means can include a number of typically used mechanical, hydraulic, pneumatic or other means. In one embodiment, the graphite is retrieved by mechanically or “dry” cutting the graphite from the nuclear core of the reactor. If this option is employed, preferably, a remotely operated mechanical “nibbler” or cutter is used to reduce the size of the retrieved graphite blocks so that smaller pieces of graphite can be transferred from the nuclear reactor core to the mechanical sizing unit. Once cut from the core, the graphite is transferred pneumatically, or by other means, through an enclosed transfer system. Past graphite removal efforts could also be employed that have involved manual or robotic removal of large blocks of graphite. These large blocks of graphite could be transferred to a treatment system sizing means. In an alternative embodiment, a water jet cutting technique is employed along with a water slurry transfer system to retrieve the graphite from the core and move the graphite to the mechanical sizing unit. Regardless of the particular means employed to retrieve the graphite from the nuclear core, the processing system of the present invention will be capable of handling a wide variety of sizes of graphite blocks and pieces.

Next, the retrieved graphite, which includes large blocks and randomly sized pieces, is sized by a mechanical sizing unit 14 enclosing a means for mechanical sizing 18 the graphite. The mechanical sizing unit can also employ a variety of means and features to facilitate the sizing of the graphite. In one embodiment, the mechanical sizing unit includes an airlock inlet storage hopper 16 for the introduction of large blocks of graphite or randomly sized pieces of graphite to a thermal roaster (MBR) 20 to initiate the first stage of the present invention. This storage hopper 16 is provided with argon, CO₂, nitrogen or other substantially inert blanket gas and means for reducing the size of the graphite pieces. Furthermore, the storage hopper 16 provides a holdup capacity to the present system.

In operation, the graphite pieces will pass through the CO₂ or nitrogen blanketed sizing means 18, which is capable of reducing the size or sizing the graphite pieces to about less than 20 mm (less than ¾ inch) in size. This small size is desirable to enhance the volatization of loosely held radionuclides from the graphite. Preferably, the sizing means 18 is a customized jaw or a rotary crusher that is dimensioned to reduce the size of the graphite to <20 mm sized pieces while also reducing the potential production of fines. Additionally, the sizing means 18 can include the use of a water seal to seal the sizing means from the MBR 20. Preferably, the sizing means 18 is operated at a low speed, about <100 rpm, that generates a low amount of fines, about <5%.

Once the graphite pieces have been sized, they are fed through a sealed lock-hopper 17 to the MBR 20 to undergo the first stage of the present system. In one embodiment, a means to use slurry transfer of retrieved graphite from the reactor core to the sizing means 18 can be used. Water will separate by gravity and seal the bottom of the sizing means 18 with solids being mechanically transferred from the bottom of the sizing means 18 to the sealed lock-hopper 17 to the MBR 20. The MBR 20, which is shown in more detail in FIG. 2 includes a refractory lined vessel 22 with an internal shell or liner 24 that can be preferably electrically heated. Preferably, the MBR 20 is dimensioned to contain approximately 24 hours of throughput of graphite. Additionally, the MBR 20 includes an inlet for the introduction of graphite and, optionally, a separate inlet for oxygen above the normal graphite levels in the side of the vessel 22, as well as two outlets, 23 and 25, one for outlet gases and fines exiting the MBR 20, and one for roasted graphite, which can also serve as the inlet for purging gases.

The use of an electrically heated MBR 20 is a feature of the present invention, as electrical heat will eliminate the need to produce energy within the MBR, such as by the addition of oxygen, which would oxidize the graphite. Because a goal of the present invention is to volatize and remove an amount of radionuclides, including C-14, the oxidation of the graphite in the roaster to produce a carbon-oxide gas, including CO or CO₂, would dilute the very C-14 containing CO and CO₂ that is being separated and concentrated. A small amount of oxygen that is introduced occasionally or periodically, however, may be needed to help oxidize certain species of radionuclides in the pores of the graphite to enhance their mobility so that they can be removed from the graphite pores more readily.

Preferably, the graphite pieces are introduced from the sealed inlet lock-hopper 17 into the top of the MBR 20 so that the graphite can move from the top of the vessel 22 to the bottom in a continuous, or semi-continuous manner. Once the pieces are within the MBR vessel 22, the temperature of the internal shell 24 is heated to an operating temperature of between about 400° to about 1200° C. The graphite bed moves downward through the slow semi-continuous removal of graphite out the bottom of the MBR 20. Preferably, the operating temperature is between about 600° to about 1100° C., and most preferably it is between about 700° to about 1000° C. During this heating, the graphite pieces move slowly down the height of the MBR 20 and are removed from the bottom and thereafter transferred to a graphite gasification steam reformer (GGR) 50 to initiate the second stage of the present system.

Upon reaching a suitable operating temperature, the graphite is soaked or kept at this temperature to allow the volatile radioactive materials that are mechanically trapped in the spaces or pores of the graphite to migrate out of the graphite. The soaking time required to sufficiently volatize the radioactive materials on the surfaces and pores of the graphite is between about 2 to 36 hrs, with the preferred soaking time being between about 4 to 24 hrs, and the most preferred soaking time being between about 10 to 18 hrs. Depending on the particular radionuclides contained in the graphite, the roasting and soaking steps will facilitate the volatization and migration of C-14, H-3, and Cl-36. The C-14 takes two forms in graphite. There is C-14 as a component of CO2, which is produced from the neutron flux activation of nitrogen. The second is C-14 produced within the graphite structure from the activation of C-13. The C-14 produced from the activation of nitrogen can be diffused from the pores of the graphite through heating and purging. The remaining C-14 must be gasified. Preferably, about 40% to about 60% of the C-14, and a majority of the H-3 and Cl-36 trapped in the graphite is volatized and removed from the graphite during this stage of the system while preventing the gasification of the base graphite.

To further facilitate the volatization of radionuclides from the graphite, a small flow of purge gases, which can include both inert and reactive gases, is introduced to the bottom of the MBR so that the purge gases flow upwards as the graphite pieces move slowly downward. Inert purge gases include argon, nitrogen, and/or CO₂, and reactive purge gases include oxygen, oxygen containing gases like CO, and/or steam. Also, organic vapors that contain oxygen in the molecules, as well as inert gases such as CO₂, can be employed.

The countercurrent flow of purge gases enhances the volatization and diffusion of the radionuclides from the graphite although a co-current roaster can also be used. Because inert and/or reactive gases are introduced to the MBR 20, the radionuclides are carried out in a number of forms. In particular, if the graphite contains loosely held C-14, this will be volatized and carried out of the MBR as CO₂ gas. The C-14 will be converted to CO and CO₂ by the steam and/or oxygen that is introduced. The H-3 is reacted and volatized by the steam and/or oxygen to make H₂O or gaseous H₂. Furthermore, if H-3 gas is adsorbed in the graphite matrix, the purge gas flow can desorb this gas from the graphite. The Cl-36 is reacted and volatized by the purge gases to make HCl. Furthermore, if the Cl-36 is an adsorbed gas in the graphite matrix, it can also be volatized or desorbed by the purge gas flow. Other radionuclides (e.g., Co60, Fe55) that are not volatized or reacted remain in the graphite which proceeds to the second stage GGR 50.

Preferably, the C-14 CO₂ is concentrated by a factor of up to 50× by the preferential volatization of much of C-14 without the equivalent gasification of the graphite. It is thus important to limit the level of oxidizing gas that is introduced to the MBR 20. Although a small amount of oxygen is useful in converting any CO formed by the steam reforming reactions between the graphite and the steam to CO₂, the gasification of the graphite is preferably limited to no more than about 2% to 4%. To ensure any CO within the unit is converted to CO₂, however, oxygen gas is also introduced at the top of the MBR 20.

This countercurrent flow of gases is further combined with pressure swings and/or vacuum swings in the MBR 20 to drive the gases in and out of the pores or spaces of the graphite to enhance otherwise slow diffusion of the volatized radionuclides from the graphite. If only vacuum swings are employed, these swings may be from about −200 inch WC to about −10 inch WC. If only pressure swings are employed, the pressure may be from about ambient to about 30 psig or even higher. Alternatively, both pressure and vacuum swings can be employed. Throughout the pressure/vacuum swings, the operating temperature will remain about the same, and the pressure/vacuum swings will be cycled over time with a cycle starting as soon as the previous one is completed. The preferred protocol for using temperature, pressure, and/or vacuum conditions in the MBR 20 will be based on analysis of radionuclides, which are specific for each graphite source, in parametric test runs that will determine the optimum removal efficiency (% removed) as a function of composition of purge gas, temperature, and pressure cycling speed and depth of pressure variation.

In a continuous or semi-continuous manner, roasted graphite will exit the MBR 20 from the bottom outlet 23, and a gas stream containing a mixture of purge gases and volatized radionuclides will exit the MBR 20 from an upper outlet 25. Processing steps relating to the radionuclide containing outlet gas stream will be discussed further below.

The roasted graphite will next enter the GGR 50 to undergo the second stage of the present system. The fine solids that carryover from the MBR 20 are collected in a roaster outlet gas filter (RGF) 800 and then transferred to the GGR 50. The RGF 800 is a small filter that will contain a set of silicon carbide or sintered powdered metal filter elements for efficient removal of particulate in the MBR 20 outlet gas stream. The RGF 800 is optionally provided with a small sealed lock-hopper that will transfer the fine graphite solids to the GGR 50 by dilute or dense phase transfer using CO₂ as the transfer gas. Larger graphite solids are transferred from the bottom of the MBR 20 to the GGR 50. In this context, the term “roasted” means that a portion of the volatile radionuclides contained within the graphite has been removed in the MBR 20. The GGR 50 is a feature of the present invention, as it efficiently gasifies graphite while producing a minimum volume of process gases that require treatment. Destruction of the graphite is achieved in the GGR 50 through heating of the graphite at a temperature of about 800° to 1200° C., preferably 900° to 1100° C., in a steam and/or oxygen environment, which gasifies the graphite into CO₂ and CO. Generally, GGR 50 includes a vertical, refractory lined vessel that employs a fixed and/or fluid bed system and autothermal steam reforming conditions to gasify the graphite and release the remaining fraction of H-3, Cl-36 and C-14, as well as to separate non-volatile radionuclides (Co-60, Fe-55, etc.) that are also contained in the graphite structure. As used herein, “autothermal” refers to the internal heating conditions provided by the heated steam introduced to the vessel and/or high energy release from the graphite gasification to CO and CO₂.

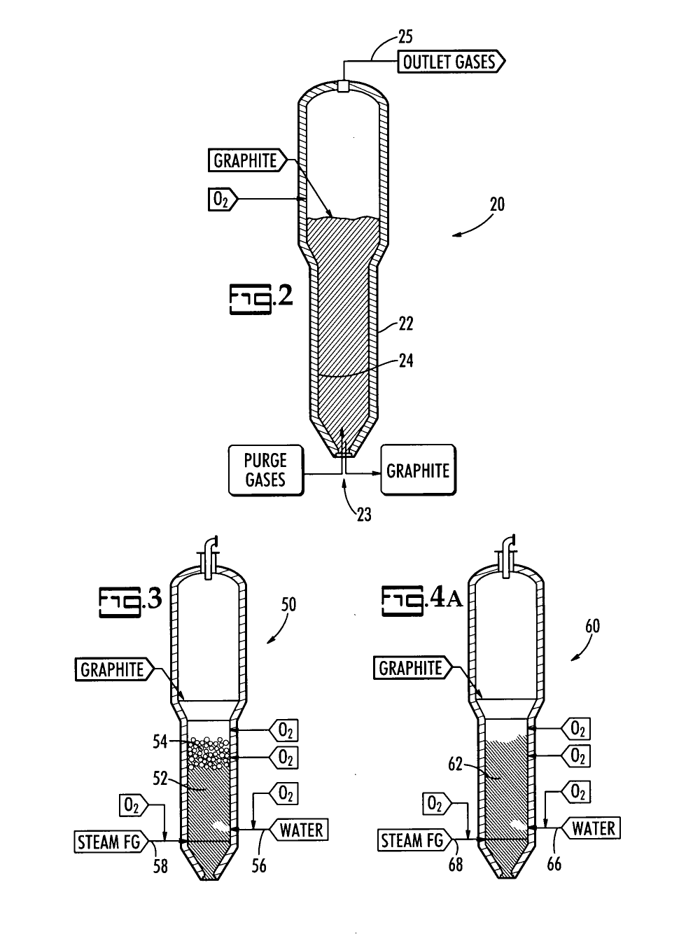

A number of operation modes can be used to react the graphite within the GGR 50. As shown in more detail in FIG. 3, a preferred embodiment of the GGR 50 includes a lower fixed bed 52 that includes larger pieces of graphite and an upper fluidized bed 54 that includes smaller pieces of graphite that are fluidized by fluidizing gases. As used herein, “fluidize” means to suspend or transport finely divided particles in a stream of gas or air. The particles of graphite in the fluidized bed 54 are such that when acted on by fluidizing gases, these particles act as a fluid in a generally bubbling bed mode. At the lower portion of the fixed bed 52, the GGR 50 includes water and oxygen jets 56 and/or a steam and fluidizing gas inlet 58. Oxygen can also be introduced at or above the fluidized bed 54 so as to ensure that any CO produced within the GGR 50 is converted to CO₂. The fluidizing gases typically include steam or steam and oxygen although other fluidizing gases can be used such as nitrogen, carbon dioxide, and other oxygen-containing or inert gases. The term “fixed bed” refers to any bed of solid particles that are not fully fluidized and includes a slowly moving bed of solids that generally move downward over time, as well as non-continuous or partially fluidized beds.

To initiate the reforming reactions, heated steam from a boiler 300 is introduced to the lower portion of the fixed bed 52. Because the graphite in the GGR 50 is heated and reacted at the lower portion of the fixed bed 52, the graphite particles in this area of the GGR 50 will shrink in size as the gasification or reforming products (CO and H₂) rise up through the voids between the larger fixed bed 52 graphite particles. Thereafter, the larger particles will migrate or settle to the bottom to take the place of the smaller particles similar to the larger graphite particles in the MBR 20. The smaller graphite particles are more easily fluidized. Thus, as the graphite is being reformed, the fluidized bed 54 continues to grow and the fixed bed 52 continues to shrink in size. The settling of the larger particles is further facilitated through the use of the water oxygen jet 56, which provides agitation to localized areas within the generally fixed bed 52 particles.

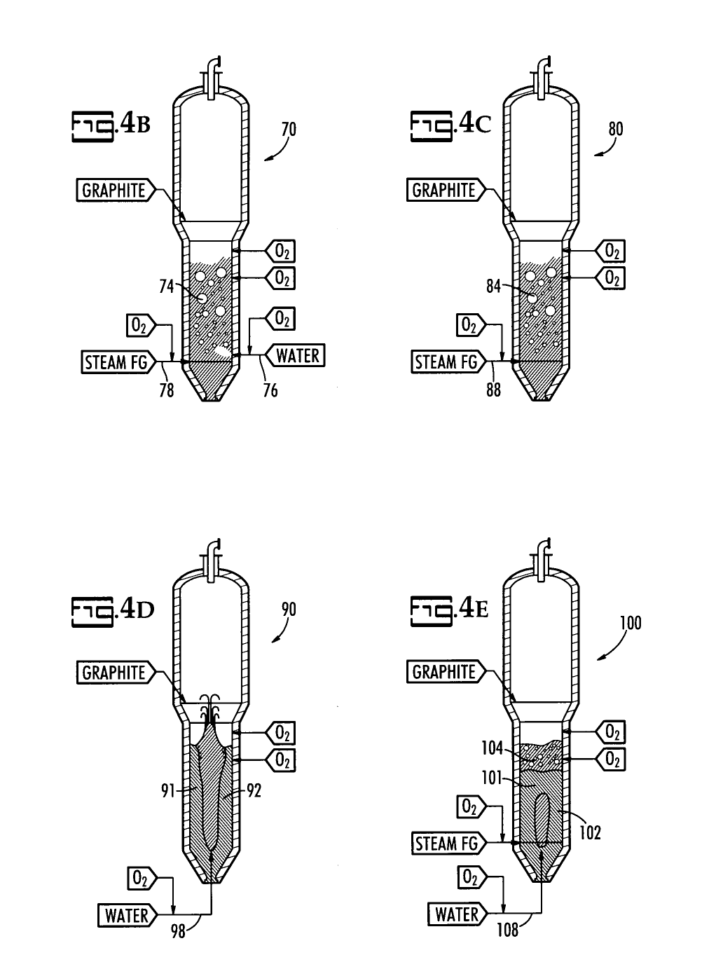

In a first alternative embodiment shown in FIG. 4A, the GGR 60 includes only a fixed bed 62. At the lower portion of the fixed bed 62, the GGR 60 includes a water and oxygen jet 66 and/or a steam and fluidizing gas inlet 68. Oxygen can also be introduced at or above the top portion of the fixed bed 62 so as to ensure that any CO produced within the GGR 60 is converted to CO₂. This operation mode may be preferred from an energy standpoint if the gas flows employed are very low such that the smaller particles produced in the bottom of the fixed bed 62 are not carried out as fines and are consumed within the bed, hence there is substantially no fluidized bed above the fixed bed.

In a second alternative embodiment shown in FIG. 4B, the GGR 70 includes only a fluidized bed 74, also referred to as a “bubbling” bed. At the lower portion of the fluidized bed 74, the GGR 70 includes a water and oxygen jet 76 and/or a steam and fluidizing gas inlet 78. Oxygen can also be introduced at or above the top portion of the fluidized bed 74 so as to ensure that any CO produced within the GGR 70 is converted to CO₂. This operation mode may be preferred from an efficiency standpoint if the graphite particles being gasified and reformed are small enough to become fluidized.

The third alternative embodiment shown in FIG. 4C is nearly identical to the second alternative embodiment shown in FIG. 4B, except that a water and oxygen jet is missing. The GGR 80 includes only a fluidized bed 84, also referred to as a “bubbling” bed. At the lower portion of the fluidized bed 84, the GGR 80 includes a steam and fluidizing gas inlet 88. Oxygen can also be introduced at or above the top portion of the fluidized bed 84 so as to ensure that any CO produced within the GGR 80 is converted to CO₂.

In a fourth alternative embodiment shown in FIG. 4D, the GGR 90 includes a spouted bed 91 that is formed by a water and oxygen jet 98 or a steam and oxygen jet (not shown) that is introduced to the bottom of the vessel so that a spout entirely penetrates a fixed bed 92 of graphite particles. Oxygen can also be introduced at or above the top portion of the spouted bed 91 so as to ensure that any CO produced within the GGR 90 is converted to CO₂. This may be preferred from an efficiency standpoint.

In a fifth alternative embodiment shown in FIG. 4E, the GGR 100 includes a partially spouted lower bed 101 and an upper fluidized bed 104. At the lower portion of the partially spouted bed is also included a steam and fluidizing gas inlet 68. The partially spouted bed 101 is formed by a water and oxygen jet 108 (or a steam and oxygen jet (not shown)) that is introduced to the bottom of the vessel so that a spout partially penetrates a fixed bed 102 of graphite particles. Oxygen can also be introduced at or above the top portion of the fluidized bed 104 so as to ensure that any CO produced within the GGR 100 is converted to CO₂. This may be preferred from an efficiency standpoint.

Although the operation modes of the GGR 50 can vary, the inorganic ash from the gasification of the graphite and gases formed from steam reforming and oxidizing reactions are processed similarly. The inorganic ash, including the non-volatile radionuclides, is converted into small granules by the introduction of an additive in the GGR 50 that mineralizes the metals and metal oxides in the ash into stable non-volatile spinels and minerals, generally fine particulates. The elutriated fine graphite and ash particles and reformed gases are sent to a graphite gasification cooler (GGC) 202. The inorganic residues from the steam reforming reactions are largely removed by the GGC 202 with the balance being removed by a graphite gasification filter (GGF) 206. The removed ash, as well as metal oxides, and metal spinel particles are transferred as a slurry to an optional slurry concentrator filter (SCF) 600, described further below, and then to a solidification unit 500 where they are solidified into a cement matrix for disposal as solid waste 502.

More specifically, reformed gases (mainly steam and CO₂) and elutriated graphite and ash fines exit the GGR 50 at line 200 and enter the GGC 202, which is a venturi scrubber/condenser/cooler that quenches and cools the high temperature gases to the steam saturation temperature of the process. Cooling in the GGC is provided by an external closed loop chiller system. The GGC 202 is provided with an integral wet scrubber to remove any Cl-36 as a salt with the addition of caustic materials (e.g., NaOH or similarly basic materials) and to remove fine graphite particles in the GGR outlet gas for recycle to the GGR 50.

After entering the GGC 202, the fine graphite particles are returned to the GGR 50 as a water/graphite slurry through line 204 for gasification. Oxygen is used to atomize the water/graphite fines slurry into the GGR 50 to improve the efficiency of fine graphite gasification that is problematic in other types of thermal treatment systems. As solids accumulate in the GGC 202, a portion of the solids is transferred to the slurry concentrator filter (SCF) 600, where graphite fines are removed from the more dense metal oxides, metal spinels and mineralized ash particulates. In particular, the SCF 600 includes a small settling/filtration unit that is dimensioned to differentially separate graphite fines from other insolubles in the water stream from the GGC 202 and a roaster condenser scrubber (RCS) 700 that will be described in more detail below. The non-graphite insolubles produced in the process include: inorganic ash constituents and non-volatile radionuclides that are in granular form as spinels, metal oxides, fused ashes, and other mineral forms. These insolubles are heavier than the very fine graphite particles and can be reasonably separated using nuclearized versions of standard industrial equipment. “Nuclearized” means that versions of standard industrial equipment are modified to provide suitable levels of radiation shielding and to facilitate remote maintenance and cleaning after use. The non-graphite insolubles and some of the water and dissolved solids are periodically removed from the SCF 600 and transferred to the solidification unit 500, where they are solidified into stable monoliths. Essentially all the H-3 as water and all non-volatile radionuclides are thereby made into stable solid matrices for disposal as a solid waste. Since the gamma producing radionuclides, mainly Co-60 and Fe-55, are concentrated into a small volume waste form, the SCF 600 and the solidification unit 500 require shielding. A portion of the filtered water is separated in the SCF 600 and is pumped to the boiler 300, thereby recycling the process water ultimately to the MBR 20 and the GGR 50 as steam. This recycle of process water serves to concentrate salts, such as the low concentration Cl-36, in the boiler 300 blowdown that is generally directly discharged as a liquid waste or optionally input to the solidification unit 500 as the water source for preparing the solidification matrix.

A feature of the present invention includes the use of a GGR 50 that can accommodate a high concentration of graphite fines that are almost impossible to handle and gasify in an air combustion-fired incineration unit. The recycle of the graphite fines in a water slurry from the GGC 202 to the GGR 50 is atomized with oxygen-containing gases into the bottom of the GGR 50 ensures that graphite fines will be efficiently gasified with good temperature control. The input of liquid water serves as a very effective, high capacity heat sink for the process as a result of autothermal energy generation from exothermic oxidizing reaction of oxygen and the fine graphite particles. The upper section of the GGR 50 operates with a separate injection of oxygen to convert any CO and hydrogen to CO₂ and water vapor so that no downstream oxidizer is required.

The steam cooled and condensed by the GGC 202 is also reused or further processed. For example, the steam and the balance of H-3 that is volatized as water vapor can be condensed for reuse as cooling water in the GGR 50 and for the makeup of water to feed the boiler 300, which provides heated steam to the GGR 50 and MBR 20. Furthermore, the high energy released from the graphite gasification to CO₂ can be adsorbed by the injection of water slurry from the GGC 202. The water/fines slurry is atomized into the GGR by a metered quantity of oxygen-containing gas 220. Through the use of evaporation of the water the temperature of the GGR 50 is more easily controlled so as to prevent certain radionuclides from volatizing, such as Co-60 and Fe-55. The use of direct water injection with oxygen-containing gas atomization will also provide for high throughputs in a relatively small reformer unit.

The cooled low moisture gas stream exiting the GGC 202 is preferably double filtered through the GGF 206 to remove any non-volatile radionuclides and any remaining fine graphite particles from the gas stream. Preferably, the GGF 206 is a pulse-back filter vessel with sets of sintered metal filter elements that are designed to remove >99.95% of particulates smaller than 0.3 micron. The GGF 206 filter media is periodically cleaned by means of pressurized CO₂. The GGF is followed by a HEPA filter with bag-in and bag-out capability.

The fines removed by the GGF 206 are returned to the GGC 202 through line 230 where the particulates are mixed with the condensed water in the GGC 202 and thereafter returned to the GGR 50 as a water/graphite fines slurry through line 204. Alternatively, the GGF 206 is provided with a small sealed lock-hopper that will transfer the fine graphite solids directly to the GGR 50 by dilute phase transfer using CO₂ as the transfer gas. The filtered gas stream is then passed through a moisture adsorber 208 where residual moisture and final traces of H-3 water are removed from the gas stream.

The moisture adsorber 208 is preferably a vessel that contains a regenerable bed of adsorption media that is designed to remove residual water vapor from the gas stream. The removal of the residual water vapor will ensure that essentially all of the H-3 water is removed from the gas stream before the gas is discharged into the environment. The water that is collected from the regenerable adsorption media is recycled back to the boiler 300 to provide a source of water.

Accordingly, the boiler 300 of the present invention receives water from a number of sources within the present system. The boiler 300 is preferably a customized electrically heated steam generator that receives filtered water from the RCS 700, described below, and the GGC 202 after being filtered in the SCF 600. The boiler 300 employs a special alloy construction to provide the required steam for use in the MBR 20 and the GGR 50. Dissolved solids, such as Cl-36 and soluble ash constituents in the graphite are concentrated in the boiler 300. Further, the pH of the water in the boiler 300 is adjusted with caustic addition to keep the pH preferably between 6 and 10.

When dissolved solids in the boiler water reach the maximum desired solids concentration, the boiler 300 is blown down, meaning that a portion of this water with dissolved solids is removed from the boiler 300. The boiler blow-down water can be either directly discharged as a liquid or the small volume of blow-down can be solidified into a cement matrix. The majority of the Cl-36 will be in this blow-down water as sodium chloride or alternative salt or mineral.

If the release of Cl-36 as a liquid or solidified matrix is unacceptable due to the high mobility of Cl-36 in the disposal facility, an optional small scale pyrolysis mineralizer evaporator could be added to process the boiler blow-down into a stable, water insoluble mineral monolith. The pyrolysis/mineralizer is an electrically heated drum-sized thermal treatment unit. Clay is mixed with the boiler blow-down and the water/clay slurry with dissolved salts are sprayed or injected into the pyrolysis/mineralizer where the salts are converted into water insoluble alumino-silicate minerals in a monolithic form. The Cl-36 NaCl is preferably converted to a water insoluble mineral called Sodalite, Na₆[Al₂O₃-2 SiO₂]₆-2NaCl.

Upon exiting the moisture adsorber 208, the dry gas stream, which is a low volume CO₂-rich gas with residual C-14 as CO₂, can then be directly discharged into the environment through a stack 402 or it can alternatively be converted to water soluble carbonates in an optional mineralization unit 400 and discharged as an aqueous soluble carbonate liquid. Alternatively, the C-14 CO₂ can be directly discharged as gas from the GGR 50. The mineralization unit 400 can be a combination pyrolysis and mineralization unit. Alternatively, the graphite from the GGR 50 can be transported to the mineralization unit 400 and thereafter discharged as an aqueous soluble carbonate liquid. Additionally, the CO₂ could be liquefied by a CO₂ amine liquefaction unit such as made commercially available by the Wittemann Company, and described in U.S. Pat. No. 2,663,154, which is incorporated herein by reference. The concentrated CO₂ liquid could then be shipped to an alternative release/discharge point for vaporization and discharge as a low volume gas.

A feature of the present invention includes the use of low gas flows as compared with typical air combustion-fired incineration units. The use of steam in the GGR 50 allows for simple condensation of the water vapor to remove the bulk of the thermal process outlet gas stream flow leaving a mainly CO₂-rich gas stream for conversion to a soluble carbonate solution using the optional mineralization unit 400 or that is amenable to simple separation and liquefaction using small scale commercially available CO₂ recovery systems with the addition of the optional CO₂ liquefaction unit.

As previously discussed, the radionuclide containing outlet gas stream from the MBR 20 requires further processing prior to disposal or release into the environment. This additional processing can be achieved by a variety of optional methods or means. In one embodiment, the outlet gas stream is filtered through a downstream roaster gas filter (RGF) 800 to remove and collect any fine graphite particles that may be present in the gas stream. Any such collected solids will be transferred to the GGR 50 for the purpose of gasification of the particles. More specifically, the RGF 800 is a small, high temperature filter that contains a set of silicon carbide or sintered powdered metal filter elements. The RGF 800 is preferably provided with a small sealed lock-hopper that is connected to a transfer system, whereby fine graphite solids are transferred pneumatically by dilute phase transfer or dense phase transfer using CO₂ as the transfer gas.

Once filtered, the radionuclide containing gas stream is sent to a combined condenser and scrubber, referred to herein as the roaster condenser scrubber (RCS) 700, which is used to condense the water vapor contained in the gas stream to remove H-3 as water, and the remaining gases are scrubbed with the condensed water solution to remove Cl-36 as salt. Alternatively, the radionuclide containing gas stream can be sent directly from the MBR 20 to the RCS 700 without the need for an upstream filter. In particular, the RCS 700 is a small sized wet scrubber that includes a chilled water recirculation system that is used to condense a majority of the water vapor in the outlet gas stream. The condenser water will adsorb substantially all of the amount of Cl-36 that was volatized in the roaster unit. The condensed water and collected Cl-36 will than be pumped to the SCF concentrator 600 previously described for removal of any undissolved solids in the solution. The partially cleaned water with traces of dissolved species, including the Cl-36, will then go to the boiler 300 to be used as a water source or otherwise disposed as boiler blow-down water, as previously described.

Optionally, the small amounts of non-condensable gases, such as carbon-oxide gases, and mainly CO₂-rich with both C-14 and C-12, resulting from the condensed and scrubbed outlet gas stream are passed through a CO₂ liquefaction system 900. As used herein, the term “carbon-oxide” can include CO and CO₂ and is interchangeable with CO and CO₂. This CO₂ liquefaction system removes, concentrates and liquefies the carbon-oxide, including C-14 carbon dioxide, for remote discharge or for further treatment to concentrate the C-14 in a CO Converter 904 and a PSA C-14 Separator 906. If further treatment through the CO Converter and Pressure Swing Adsorption (PSA) Separator is required, it is preferred to liquefy the CO₂ for ease of storage and so that the cyclical gas flows from the MBR 20 will not impact the operation of the CO Converter 904 and the PSA Separator 906, which both require a stable gas flow for optimal performance. The liquefied CO₂ is therefore vaporized as required to meet the process flow requirements of the CO Converter 904 and PSA Separator 906.

In one embodiment, the CO₂ liquefaction system is a small capacity unit that includes a simple chilled condenser 902 that condenses CO₂ as liquid or solid. In an alternative embodiment CO₂ liquefaction unit is a small capacity unit that includes an amine based CO₂ recovery and liquefaction system, such as the liquefaction system made commercially available by the Wittemann Company as previously described. There exist a number of other commercially available systems that are suitable for the liquefaction of CO₂.

Once the CO₂ is liquefied, the CO₂ is optionally sent to the CO Converter 904 that includes a catalytic fixed bed for the conversion of CO₂ to CO gas. The CO₂ must be vaporized prior to entry into the CO Converter 904. This CO gas is then passed through the PSA C-14 separator 906 for the separation of C-14 CO from C-12 CO. If the PSA Separator 906 is to be used in the flow path, oxygen can be omitted from the top of the MBR 20 to maximize the CO content of the MBR 20 outlet gases to thereby minimize the load on the CO Converter 904. The PSA separator 906 includes several, automated adsorption columns that are filled with a special zeolite media. In operation, the CO gas passes through the zeolite adsorption columns at a controlled temperature and pressure so that substantially all of the CO (both C-12 and C-14 forms) is adsorbed on the zeolite. The process flow is then reversed and the pressure adjusted such that the C-14 carbon monoxide is preferentially released by the zeolite. Through the utilization of multiple separation steps, a higher purity of C-14 based carbon monoxide can be achieved. This C-14 enriched carbon monoxide can then be incorporated into a carbonate or silicon carbide solid matrix for final disposal of the concentrated C-14 waste. Preferably, the C-14 enriched CO is converted to C-14 enriched carbon-oxide which can then be converted to a carbonate or carbide form. Alternatively, The C-14 enriched CO stream from the PSA Separator can be converted to C-14 CO₂ and can be optionally sold and further purified if necessary for beneficial reuse as C-14 in the medical or scientific fields.

The use of a PSA C-14 separator 906 is a feature of the present invention. Through the use of this separator, about 40% to 60% of the total C-14 contained in the graphite can be concentrated and converted to a stable solid matrix that has 1% to 5% of the final disposal volume of the graphite treated by the MBR 20. This provides for maximum stability of the final C-14 products with minimal impact on disposal volumes.

As an alternative to the liquefaction of the CO₂ containing outlet gas stream exiting the RCS 700, the gas stream can pass through the mineralization unit 400. This unit is a wet scrubber that adsorbs the CO₂ present in the gas stream in an aqueous solution of caustic (NaOH, lime, or other basic materials) to form soluble carbonates or mineral forms that are then discharged as a liquid or solidified into a cement matrix. Thereafter, the cleaned and scrubbed gases from the mineralization unit 400, which mainly include non-condensable gases having trace amounts of CO₂, are transferred to the moisture adsorber 208 where final traces of moisture are removed from the gas so as to also remove all traces of H-3 water from the gas stream. These cleaned non-condensable gases commingle with the offgases from the steam reformer and are discharged out of a common stack.

Those skilled in the art of steam reforming and graphite gasification systems will recognize that many substitutions and modifications can be made in the foregoing preferred embodiments without departing from the spirit and scope of the present invention.

What is claimed is:

1. A method for graphite destruction and capture of radionuclides, comprising:
providing graphite containing radionuclides;
providing a roaster;
heating said graphite in said roaster;
removing a first amount of radionuclides from said graphite;
providing a steam reformer;
reacting said graphite with a reforming agent in said steam reformer to form a carbon oxide;
removing a second amount of radionuclides from said graphite;
processing said first amount and second amount of radionuclides.

2. The method as recited in claim 1, wherein said carbon oxide is carbon monoxide.

3. The method as recited in claim 2, further comprising:
reacting said carbon monoxide with an oxidizing agent in said steam reformer to form carbon dioxide.

4. The method as recited in claim 1, further comprising:
providing a sizing means that is operatively connected to said roaster; and
sizing said graphite with said sizing means.

5. The method as recited in claim 4, wherein said sizing means is a crusher dimensioned to reduce the size of said graphite to pieces that are about less than 20 mm, while also reducing the potential production of graphite fines.

6. The method as recited in claim 4, wherein said sizing means is operated at a low speed that generates a low amount of fines.

7. The method as recited in claim 6, wherein said low speed is about less than 100 rpm, and wherein said low amount is about less than 10%.

8. The method as recited in claim 6, wherein said low amount is about less than 5%.

9. The method as recited in claim 4, wherein said sizing means includes an inert gas blanket.

10. The method as recited in claim 9, wherein said inert gas blanket is made of one or more of the following, including argon, nitrogen, and CO₂.

11. The method as recited in claim 4, wherein said sizing means includes a water seal.

12. The method as recited in claim 11, further comprising the steps of providing means for slurry transfer and transferring said graphite from a reactor core to said sizing means.

13. The method as recited in claim 4, wherein said sizing means is highly pressurized water.

14. The method as recited in claim 1, wherein said first amount of radionuclides includes a carbon-oxide gas containing C-14.

15. The method as recited in claim 14, wherein said processing step further comprises:
providing a liquefaction system;
transporting said carbon-oxide gas to said liquefaction system;
converting said carbon-oxide gas to C-14 enriched carbon-oxide; and
processing said C-14 enriched carbon-oxide for disposal.

16. The method as recited in claim 15, wherein said liquefaction system is an amine based CO₂ recovery and liquefaction system.

17. The method as recited in claim 15, wherein said liquefaction system includes a condenser, a vaporizer, a CO converter and a PSA separator, wherein said condenser, said vaporizer, said CO converter and said PSA separator are operatively connected.

18. The method as recited in claim 17, wherein said carbon-oxide gas includes CO containing C-14, and wherein said converting step further comprises:
separating said CO containing C-14 from the remaining carbon-oxide gas in said PSA separator; and
converting said CO containing C-14 to C-14 enriched carbon-oxide.

19. The method as recited in claim 15, wherein the step of processing said C-14 enriched carbon-oxide for disposal comprises converting said C-14 enriched carbon-oxide to a carbon containing compound.

20. The method as recited in claim 19, wherein said carbon containing compound comprises a carbonate, a carbide, or a silicon carbide.

21. The method as recited in claim 1, wherein said first amount of radionuclides includes a gas stream having fine particles, water containing H-3 and HCl containing Cl-36, and wherein said step of removing said first amount of radionuclides from said graphite comprises:
providing a roaster condenser scrubber that is operatively connected to said roaster; and
converting said HCl containing Cl-36 to a salt containing Cl-36.

22. The method as recited in claim 21, further comprising:
condensing said water containing H-3 from said gas stream with said roaster condenser scrubber.

23. The method as recited in claim 22, further comprising:
providing a slurry concentrator filter that is operatively connected to said roaster condenser scrubber;
transporting said condensed water containing H-3 and said Cl-36 salt to said slurry concentrator filter, wherein said water containing H-3 includes undissolved solids; and
filtering said undissolved solids from said condensed water containing H-3.

24. The method as recited in claim 23, further comprising:
providing a boiler that is operatively connected with said roaster condenser scrubber; and
transporting said water containing H-3 and said Cl-36 salt to said boiler.

25. The method as recited in claim 21, further comprising:
providing a mineralization unit, wherein said mineralization unit is a wet scrubber; and
transporting said gas stream to said mineralization unit, wherein said gas stream includes CO₂.
reacting said CO₂ with a base.

26. The method as recited in claim 25, further comprising;
reacting said CO₂ with a caustic agent to form a soluble carbonate, wherein said caustic agent comprises NaOH or another basic material; and
discharging said soluble carbonate as a liquid.

27. The method as recited in claim 25, further comprising:
reacting said CO₂ with a caustic agent to form a mineral, wherein said caustic agent comprises lime or another basic material; and
discharging said mineral as a liquid slurry or solid.

28. The method as recited in claim 1, wherein said processing step further comprises:
providing a PSA separator that is operatively connected to said roaster, wherein said first amount of radionuclides includes compounds having an amount of C-14;
passing said compounds through said PSA separator so that said compounds become C-14 enriched; and
providing a mineralization unit that is operatively connected to said PSA separator.

29. The method as recited in claim 28, further comprising:
passing said C-14 enriched compounds through said mineralization unit to form a C-14 containing mineral that is a liquid; and
discharging said liquid.

30. The method as recited in claim 28, further comprising:
providing a solidification unit;
passing said C-14 enriched compounds through said solidification unit to form a C-14 containing solid; and
discharging said C-14 containing solid.

31. The method as recited in claim 29, wherein said liquid includes undissolved solids, and wherein said undissolved are carbonates.

32. The method as recited in claim 1, wherein said processing step further comprises:
providing a CO₂ liquefaction system that is operatively connected to said roaster, wherein said first amount of radionuclides includes CO₂ containing C-14;
discharging said CO₂ containing C-14 as liquid CO₂ through the use of said liquefaction system.

33. The method recited in claim 1, wherein said processing step further comprises:
providing a CO₂ liquefaction system that is operatively connected to said roaster, wherein said first amount of radionuclides includes CO₂ containing C-14;
liquifying said CO₂ containing C-14 in said CO₂ liquefaction system;
discharging said CO₂ containing C-14 as gaseous CO₂ through the use of liquid CO₂.

34. The method as recited in claim 1, further comprising:
reacting said graphite with an additive in said steam reformer to form a liquid; and
discharging said liquid from said steam reformer.

35. The method as recited in claim 34, wherein said liquid is a dissolved solid in a liquid.

36. The method as recited in claim 35, wherein said dissolved solid is a carbonate and wherein said liquid is water.

37. The method as recited in claim 1, wherein said processing step further comprises:
providing a CO₂ liquefaction system that is operatively connected to said steam reformer, wherein said second amount of radionuclides includes an amount of CO₂ having of C-14;
passing said amount of CO₂ through said CO₂ liquefaction system; and
discharging said amount of CO₂ as liquid CO₂.

38. The method as recited in claim 1, further comprising:
providing a moisture adsorber that is operatively connected to said steam reformer, wherein said graphite includes an amount of CO₂ containing C-14;
passing said amount of CO₂ containing C-14 through said moisture adsorber; and
discharging said amount of CO₂ containing C-14 as gas.

39. The method as recited in claim 3, further comprising:
discharging said carbon dioxide from said steam reformer.

40. The method as recited in claim 1, wherein said processing step further comprises:
providing a CO₂ liquefaction system and a CO₂ vaporization system that are operatively connected to said steam reformer, wherein said second amount of radionuclides includes an amount of CO₂ having of C-14;
passing said amount of CO₂ through said CO₂ liquefaction system and said CO₂ vaporization system; and
discharging said amount of CO₂ as gas.

41. The method as recited in claim 1, further comprising:
providing a boiler that is operatively connected to said roaster and said steam reformer, wherein said graphite includes an amount of H-3, and wherein said boiler includes an amount of boiler blowdown;
converting said amount of H-3 to H₂O;
passing said H₂O through said boiler to form steam; and
discharging said boiler blowdown with said H₂O as liquid.

42. The method as recited in claim 1, further comprising:
providing a solidification system that is operatively connected to said roaster and said steam reformer, wherein said graphite includes an amount of H-3;
reacting said amount of H-3 with an oxidizing agent to form H₂O containing H-3;
solidifying said H₂O containing H-3 in said solidification system; and
discharging said solidified H₂O containing H-3.

43. The method as recited in claim 1, wherein said graphite includes an amount of H-3, and wherein said method further comprises:
reacting said amount of H-3 with an oxidizing agent in said steam reformer to form water vapor;
providing a moisture adsorber that is operatively connected to said steam reformer; and
removing said water vapor by said moisture adsorber.

44. The method as recited in claim 43, further comprising:
providing a boiler that is operatively connected to said steam reformer; and
recycling said water vapor to said boiler.

45. The method as recited in claim 1, further comprising:
providing a slurry concentrator filter that is operatively connected to said steam reformer, wherein said graphite includes an amount of non-volatile radionuclides, wherein said step of reacting said graphite with a reforming agent in said steam reformer to form a carbon oxide results in graphite ash; and
concentrating by said slurry concentrator filter said non-volatile radionuclides and said graphite ash.

46. The method as recited in claim 1, further comprising:
providing an additive to said steam reformer, wherein said step of reacting said graphite with a reforming agent in said steam reformer to form a carbon oxide results in graphite ash; and
mineralizing said graphite ash by said additive.

47. The method as recited in claim 46, wherein said mineralizing step comprises converting said graphite ash to a mineral, and wherein said mineral comprises an alkali aluminosilicate, an aluminate, a calcium-based compound, or a phosphate-based compound.

48. The method as recited in claim 1, further comprising:
providing an additive to said steam reformer, wherein said graphite includes an amount of metals; and
converting said metals to water insoluble metal spinels by said additive.

49. The method as recited in claim 48, wherein said metals are heavy metals, wherein said additive is iron, and wherein said insoluble metal spinels are insoluble iron spinels.

50. The method as recited in claim 1, further comprising:
providing an iron containing additive to said steam reformer, wherein said graphite includes an amount of iron;
converting said amount of iron to iron spinels by said iron containing additive.

51. The method as recited in claim 1, further comprising:
providing a slurry concentrator filter that is operatively connected to said steam reformer, wherein said graphite includes an amount of non-volatile radionuclides, and wherein said step of reacting said graphite with a reforming agent in said steam reformer to form a carbon oxide results in graphite ash;
reacting an iron containing additive with said amount of non-volatile radionuclides and said graphite ash to form magnetic iron-based wastes, wherein said slurry concentrator filter includes means to separate said magnetic iron-based wastes and means to concentrate iron spinels, other metal spinels, iron metal oxides, other metal oxides, and iron-based mineral forms.

52. The method as recited in claim 1, wherein said graphite includes an amount of Cl-36, and wherein said method further comprises converting said amount of Cl-36 in said steam reformer and in said roaster to an alkali or an alkaline earth metal chloride for discharge as a water-based liquid with dissolved Cl-36 salts or other water soluble compounds.

53. The method as recited in claim 52, further comprising:
providing an additive to said steam reformer;
converting said alkali and said alkaline earth metal chloride into a water insoluble minderal;
discharging said water insoluble mineral as a solid or slurry.

54. The method as recited in claim 53, wherein said additive comprises aluminum, an aluminum-silicate, or a phosphate compound.

55. The method as recited in claim 1, further comprising:
providing a boiler that is operatively connected to said steam reformer or said roaster, wherein said graphite includes an amount of Cl-36, and wherein said boiler includes an amount of blowdown water; and
converting said amount of Cl-36 in said steam reformer or in said roaster to an alkali or an alkaline earth metal chloride for discharge as a water-based liquid with dissolved Cl-36 salts or other water soluble compounds through the use of said blowdown water from said boiler.

56. The method as recited in claim 1, further comprising:
providing a slurry concentrator filter and a solidification system that are operatively connected to said steam reformer or said roaster, wherein said graphite includes an amount of Cl-36;
converting in said slurry concentrator filter said amount of Cl-36 from said steam reformer or from said roaster to an alkali or an alkaline earth metal chloride for discharge as a water-based liquid with dissolved Cl-36 salts or other water soluble compounds; and
disposing said amount of Cl-36 as a solid carbonate or a solid chlorine-containing mineral through the use of said solidification system.

57. The method as recited in claim 1, further comprising:
providing a mineralization unit that is operatively connected to said steam reformer or said roaster, wherein said graphite includes an amount of Cl-36;
providing an additive to said mineralization unit; and
converting said amount of Cl-36 in said steam reformer or in said roaster to an alkali alumino-silicate or other water insoluble mineral forms for discharge through the use of said mineralization unit.

58. The method as recited in claim 57, wherein said additive comprises clay, phosphate, iron, silica, or aluminum compounds.

59. The method as recited in claim 1, further comprising:
providing a mineralization unit and a solidification system that are operatively connected to said steam reformer or said roaster, wherein said graphite includes an amount of Cl-36;
converting in said steam reformer or said roaster said amount of Cl-36 to solid waste for discharge through the use of said mineralization unit and said solidification system.

60. The method as recited in claim 1, further comprising:
providing a slurry concentrator filter and a solidification system that are operatively connected to said steam reformer or said roaster;
forming in said steam reformer or said roaster metal oxides, metal spinels, and mineral forms, wherein said metal oxides include an amount of insoluble metal oxides, wherein said metal spinels include an amount of insoluble metal spinels, and wherein said mineral forms include an amount of insoluble mineral forms;
concentrating by said slurry concentrator filter said insoluble metal oxides, said insoluble metal spinels, and said insoluble mineral forms; and
transferring said concentrated insoluble metal oxides, insoluble metal spinels, and insoluble mineral forms to said solidification system for disposal as solid waste.

61. The method as recited in claim 1, further comprising:
providing a slurry concentrator filter and a boiler that are operatively connected to said steam reformer or said roaster, wherein said slurry concentrator filter filers water that is used and formed said boiler.

62. The method as recited in claim 1, further comprising:
providing a graphite gasification cooler that is operatively connected to said steam reformer, wherein said heating step and said reacting step result in an outlet gas, wherein said outlet gas includes Cl-36, steam, C-14 carbon-containing gases, H-3 water vapor, and particulate solids;
scrubbing or adsorbing by said graphite gasification cooler said Cl-36;
condensing said steam and H-3 water vapor by said graphite gasification cooler; and
scrubbing and removing said particulate solids as metal oxides, metal spinels, and graphite fines by said graphite gasification cooler.

63. The method as recited in claim 1, further comprising:
providing a roaster gasification condenser, wherein said reacting step results in an outlet gas that contains an amount of Cl-36, steam, C-14 carbon-containing gases, and H-3 water vapor;
cooling said outlet gas by said roaster gasification condenser;
adsorbing or scrubbing said Cl-36 by said roaster gasification condenser; and
condensing said steam and H-3 water vapor by said roaster gasification condenser.

64. The method as recited in claim 1, wherein said roaster is electrically heated.

65. The method as recited in claim 1, further comprising introducing purge gases into said roaster, wherein said purge gases comprise argon, helium, nitrogen, CO₂, CO, oxygen, oxygen containing gases, or steam.

66. The method as recited in claim 65, wherein said purge gases flow countercurrent to said graphite.

67. The method as recited in claim 1, further comprising introducing pressure cycling in said roaster.

68. The method as recited in claim 1, further comprising introducing vacuum cycling in said roaster.

69. The method as recited in claim 68, further comprising introducing pressure cycling in said roaster.

70. The method as recited in claim 1, wherein said roaster is operated at a temperature between about 600° C. and about 1200° C.

71. The method as recited in claim 1, wherein said roaster is operated at a temperature between about 800° C. and about 1100° C.

72. The method as recited in claim 1, wherein said oxidizing agent comprises oxygen or oxygen containing gas.

73. The method as recited in claim 1, further comprising:
providing a roaster condenser scrubber and a boiler that are operatively connected to said roaster, wherein said graphite includes an amount of H-3;
reacting said amount of H-3 with an oxidizing agent to form H2O containing H-3; and
recycling by said roaster condenser scrubber said H₂O containing H-3 to said boiler to concentrate said amount of H-3.

74. The method as recited in claim 1, further comprising:
providing a roaster condenser scrubber that is operatively connected to said roaster, wherein said graphite includes an amount of Cl-36; and
removing by said roaster condenser scrubber said amount of Cl-36.

75. The method as recited in claim 1, wherein said steam reformer has an operation mode.

76. The method as recited in claim 75, wherein said operation mode is fluidized.

77. The method as recited in claim 75, wherein said operation mode is a fixed bed below a fluidized bed.

78. The method as recited in claim 75, wherein said operation mode is a partially spouted bed with and without a fluidized bed on top of said partially spouted bed.

79. The method as recited in claim 75, wherein said operation mode is a fully spouted bed with and without a fluidized bed on top of said fully spouted bed.

80. The method as recited in claim 75, wherein said operation mode is a spouted bed with fluidizing gas with and without a fluidized bed on top of said spouted bed.

81. The method as recited in claim 1, wherein said steam reformer is operated at a temperature between about 800° C. and about 1500° C.

82. The method as recited in claim 1, wherein said steam reformer is operated at a temperature between about 1000° C. and about 1300° C.

83. The method as recited in claim 1, further comprising introducing water into said steam reformer to cool contents in said steam reformer.

84. The method as recited in claim 1, further comprising introducing water with an oxygen-containing atomizing gas into said steam reformer to cool contents in said steam reformer.

85. The method as recited in claim 1, wherein said heating step and reacting step result in graphite fines, and wherein said method further comprises recycling to said steam reformer said graphite fines, and substantially gasifying said graphite fines in said steam reformer.

86. The method as recited in claim 1, wherein said heating step and reacting step result in graphite fines, and wherein said method further comprises recycling said graphite fines to said steam reformer in a water-based slurry, and substantially gasifying said graphite fines in said steam reformer.

87. The method as recited in claim 1, wherein said heating step and reacting step result in graphite fines, and wherein said method further comprises recycling said graphite fines to said steam reformer in a water-based slurry and co-injecting oxygen containing gas in said steam reformer, and substantially gasifying said graphite fines.

88. The method as recited in claim 1, wherein said heating step and reacting step result in graphite fines, and wherein said method further comprises recycling said graphite fines to said steam reformer in a water-based slurry, co-injecting oxygen containing gas to substantially gasify said graphite fines in said steam reformer, and adding water simultaneous to said co-injecting step to cool the contents of said steam reformer, wherein said water is atomized by said oxygen-containing gas.

89. The method as recited in claim 1, wherein said heating step and reacting step result in graphite fines, and wherein said method further comprises providing a dry pneumatic transfer system, recycling said graphite fines to said steam reformer with said dry pneumatic transfer system, and substantially gasifying said graphite fines.

90. The method as recited in claim 1, wherein said reforming agent and said oxidizing agent are a fluidizing gas.

91. The method as recited in claim 1, wherein said reforming agent and said oxidizing agent are a water and oxygen containing gas.

92. The method as recited in claim 1, wherein said reforming agent is a fluidizing gas and wherein said oxidizing agent is a water containing gas.

93. The method as recited in claim 1, wherein said reforming agent is a fluidizing gas and wherein said oxidizing agent is a water and oxygen containing gas.

94. The method as recited in claim 1, wherein said reforming agent is a fluidizing gas and wherein said oxidizing agent is an oxygen containing gas.

95. The method as recited in claim 1, wherein said steam reformer includes a bed of graphite, wherein said reacting step results in the formation of hydrogen, and wherein said reacting step further comprises reacting said hydrogen and said carbon oxide with an oxidizing agent to form water and carbon dioxide, wherein said reacting step occurs in the upper portion of said bed.

96. The method as recited in claim 1, wherein said steam reformer includes a bed of graphite, wherein said reacting step results in the formation of hydrogen, and wherein said reacting step further comprises reacting said hydrogen and said carbon oxide with an oxidizing agent to form water and carbon dioxide, wherein said reacting step occurs above said bed.

97. The method as recited in claim 1, further comprising providing means for sizing graphite that is operatively connected to said steam reformer.

98. The method as recited in claim 1, wherein said roaster operates independently of said steam reformer.

99. The method as recited in claim 1, wherein said graphite includes an amount of hydrogen, and wherein said method further comprises reacting said amount of hydrogen with an oxidizing agent to form water in said steam reformer, and cooling said water by injecting additional water into the steam reformer.

100. The method as recited in claim 1, further comprising cooling the contents in said steam reformer by adding water and oxygen-containing atomizing gas.
